(19) United States
(12) Patent Application Publication
(10) Pub. No.: US 2025/0292112 A1
(43) Pub. Date: Sep. 18, 2025

(54) SYSTEMS AND METHODS FOR TRACKING ACTIONS OF A USER OF A DIGITAL CHANNEL AND FOR PREDICTING A NEXT ACTION OF THE USER

(71) Applicant: Verizon Patent and Licensing Inc., Basking Ridge, NJ (US)

(72) Inventor: Saikiran N. CHAVALI, Pune (IN)

(73) Assignee: Verizon Patent and Licensing Inc., Basking Ridge, NJ (US)

(21) Appl. No.: 18/602,283

(22) Filed: Mar. 12, 2024

(51) Int. Cl. G06N 5/022; G06N 7/01

(52) U.S. Cl. CPC G06N 5/022; G06N 7/01

(57) ABSTRACT

A device may identify a domain associated with a user, and may identify domain elements in the domain and convert the domain to a knowledge graph with nodes and edges. The device may receive one or more movements of an input associated with the domain, and may predict positions of the input within the knowledge graph based on the one or more movements. The device may identify closest nodes to the positions, and may determine particular domain elements that correspond to the closest nodes. The device may calculate probabilities that the input will traverse the particular domain elements, and may perform one or more actions based on the probabilities that the input will traverse the particular domain elements.

### BACKGROUND

In both online and in physical environments (e.g., retail environments), understanding and predicting user behavior is critical for enhancing user engagement and preventing loss of a customer.

### BRIEF DESCRIPTION OF THE DRAWINGS

FIGS. 1A-1L are diagrams of an example associated with tracking actions of a user of a digital channel and for predicting a next action of the user.

FIG. 2 is a diagram of an example environment in which systems and/or methods described herein may be implemented.

FIG. 3 is a diagram of example components of one or more devices of FIG. 2.

FIGS. 4 and 5 are flowcharts of example processes for tracking actions of a user of a digital channel and for predicting a next action of the user.

### DETAILED DESCRIPTION OF EXAMPLE EMBODIMENTS

The following detailed description of example implementations refers to the accompanying drawings. The same reference numbers in different drawings may identify the same or similar elements.

Traditional systems often struggle to track and respond to user actions in real time, especially when users make rapid decisions, such as closing a browser window. This delay in responsiveness can lead to missed opportunities for businesses to retain users or to offer them relevant support and recommendations. Furthermore, current systems lack the capability to accurately monitor user issues as they occur, hindering the ability to provide timely assistance or improve the user experience. Traditional systems may also be deceived by sophisticated bots that mimic human behavior, leading to inaccurate predictions and potential security risks. Additionally, these systems are often reactive rather than proactive, resulting in a lag between user action and system response. Existing systems may also need to operate in a highly resilient and costly environment, making it financially burdensome for businesses to maintain the level of service necessary to effectively track and engage users in real time.

Thus, current techniques for engaging a user in online and physical environments may consume computing resources (e.g., processing resources, memory resources, communication resources, and/or the like), networking resources, and/or other resources associated with failing to properly assist a user in a store or online with a product and/or a service, losing a customer associated with a store, failing to provide recommendations to a user of an online purchasing system due to poor insights, providing incorrect recommendations to a user of an online purchasing system due to the poor insights, and/or the like.

Some implementations described herein provide a device (e.g., a backend system or a user device) that tracks actions of a user of a digital channel and predicts a next action of the user. For example, the device may identify a domain associated with a user of a user device, and may identify domain elements in the domain and convert the domain to a knowledge graph with nodes and edges. The device may receive, from the user device, one or more movements of an input associated with the domain, and may predict positions of the input within the knowledge graph based on the one or more movements. The device may identify closest nodes to the positions, and may determine particular domain elements that correspond to the closest nodes. The device may calculate probabilities that the input will traverse the particular domain elements, and may perform one or more actions based on the probabilities that the input will traverse the particular domain elements.

In this way, the device tracks actions of a user of a digital channel and predicts a next action of the user. For example, the device may track movement of an input (e.g., a mouse cursor, a facial cursor, a hand cursor, or a body movement) associated with a user, and may calculate a velocity and a direction of the movement. The device may predict a next interaction of the user, and may take proactive actions based on this prediction, such as displaying offers or providing real-time feedback to enhance user engagement. The device may differentiate between human and non-human patterns (e.g., for authenticating the user), and may be employed in various domains, such as a video display, a real-world environment, a virtual reality environment, an augmented reality environment, or a mixed reality environment. The device may improve efficiency, security, and resource utilization compared to traditional systems, and may offer businesses a sophisticated and resource-conserving system for understanding and responding to user behavior. Thus, the device may conserve computing resources, networking resources, and/or other resources that would have otherwise been consumed by failing to properly assist a user in a store or online with a product and/or a service, losing a customer associated with a store, failing to provide recommendations to a user of an online purchasing system due to poor insights, providing incorrect recommendations to a user of an online purchasing system due to the poor insights, and/or the like.

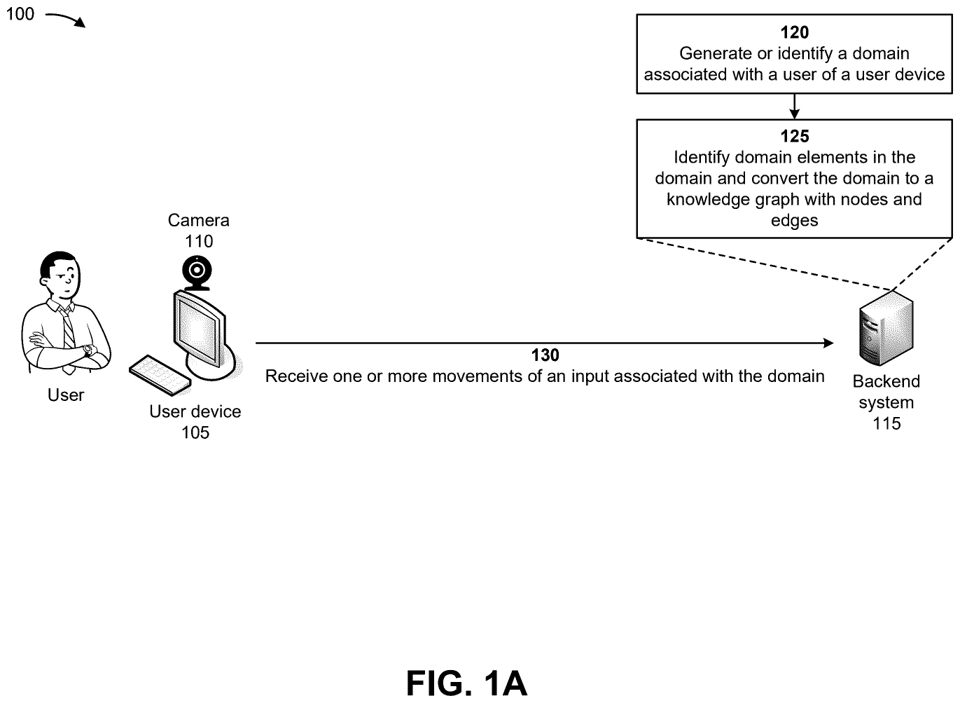

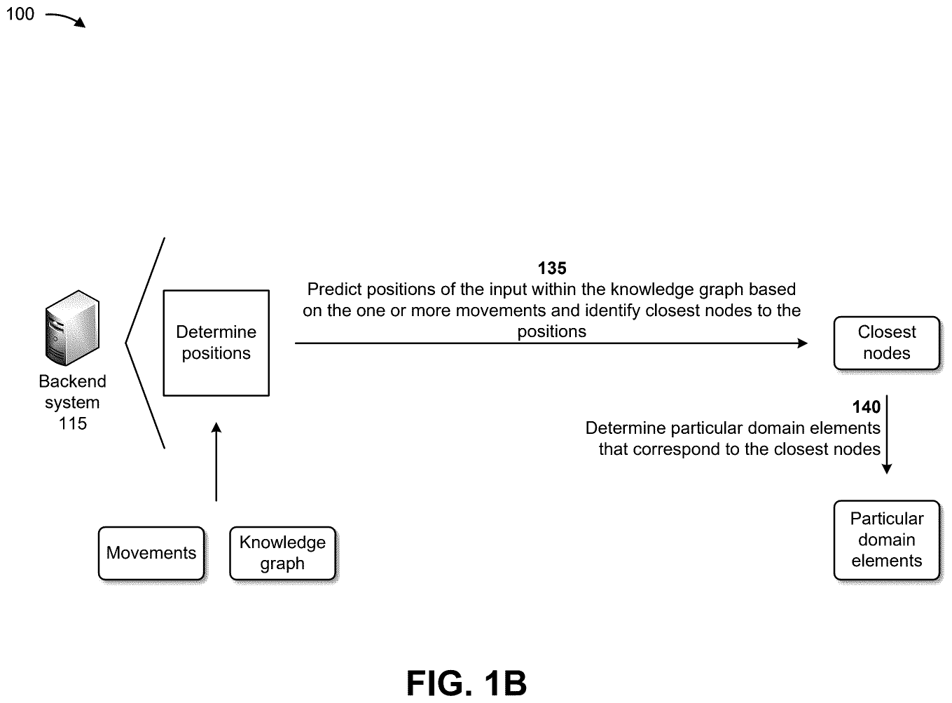

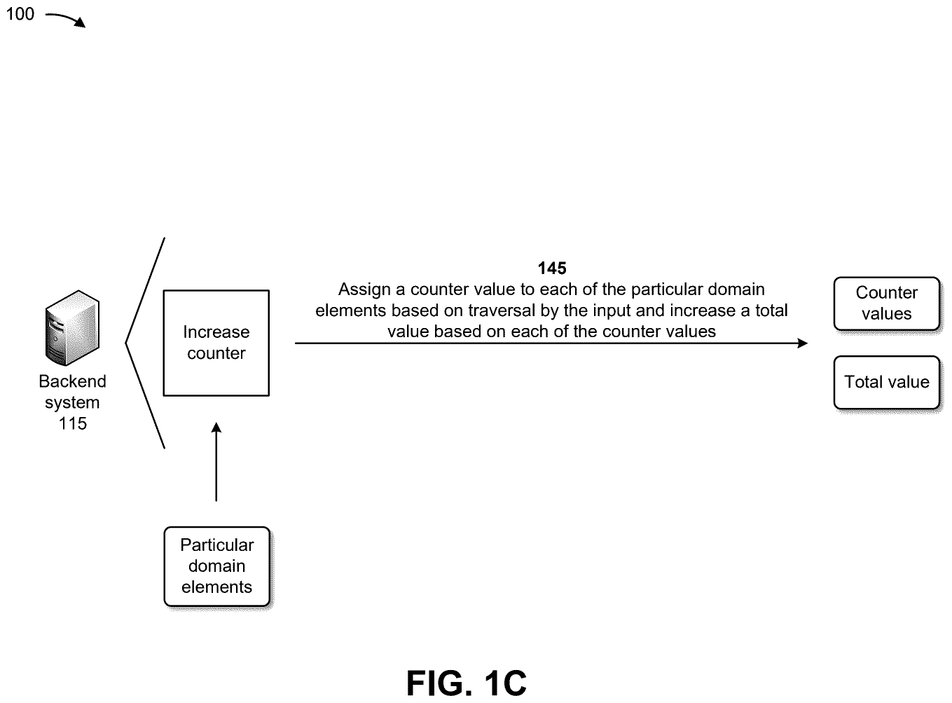

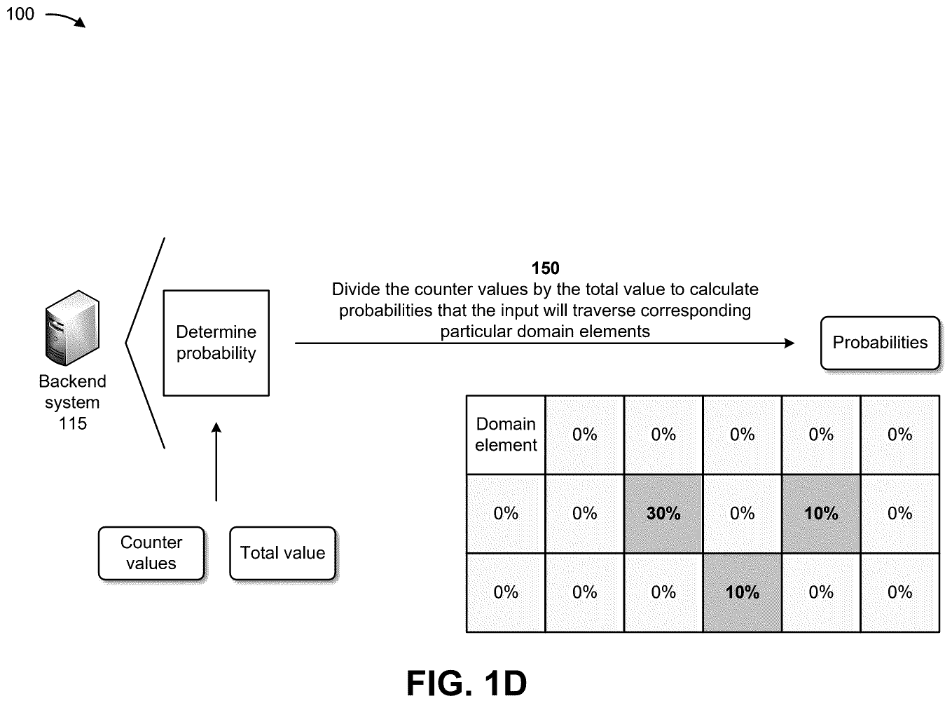

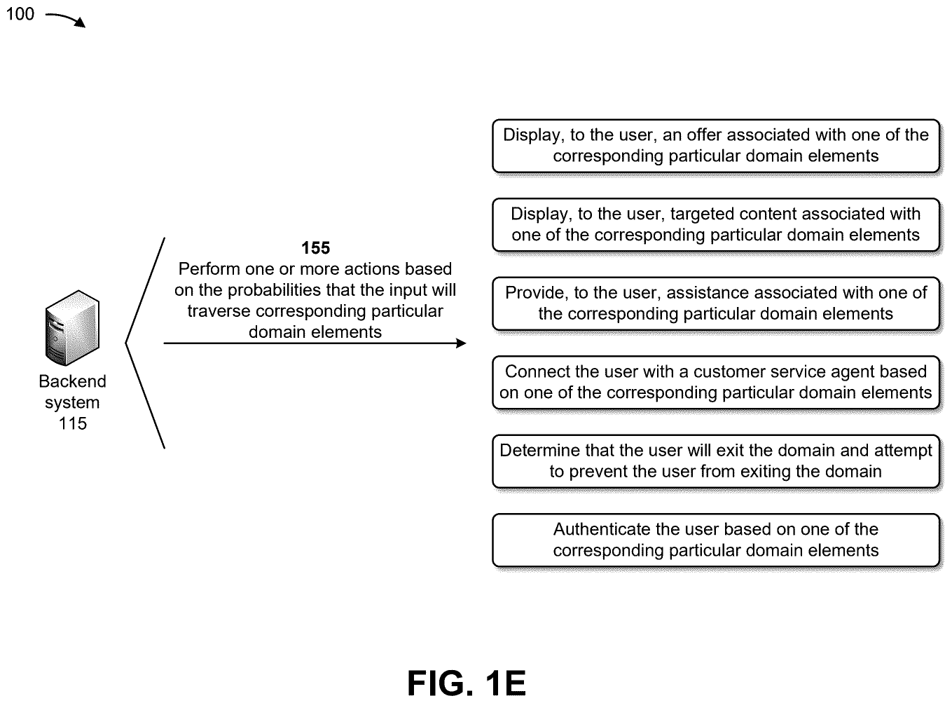

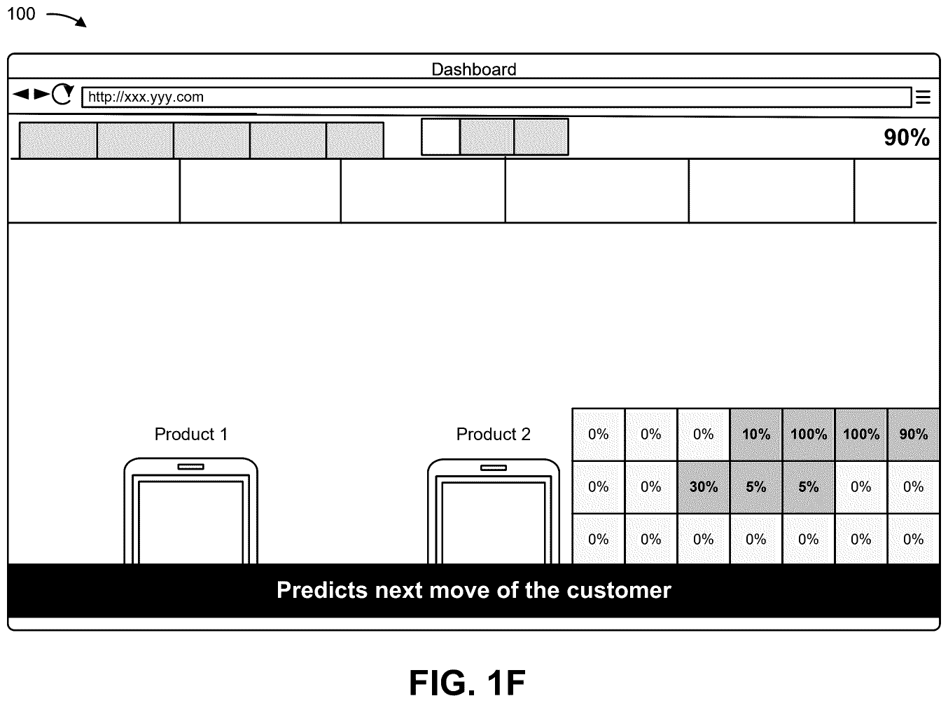

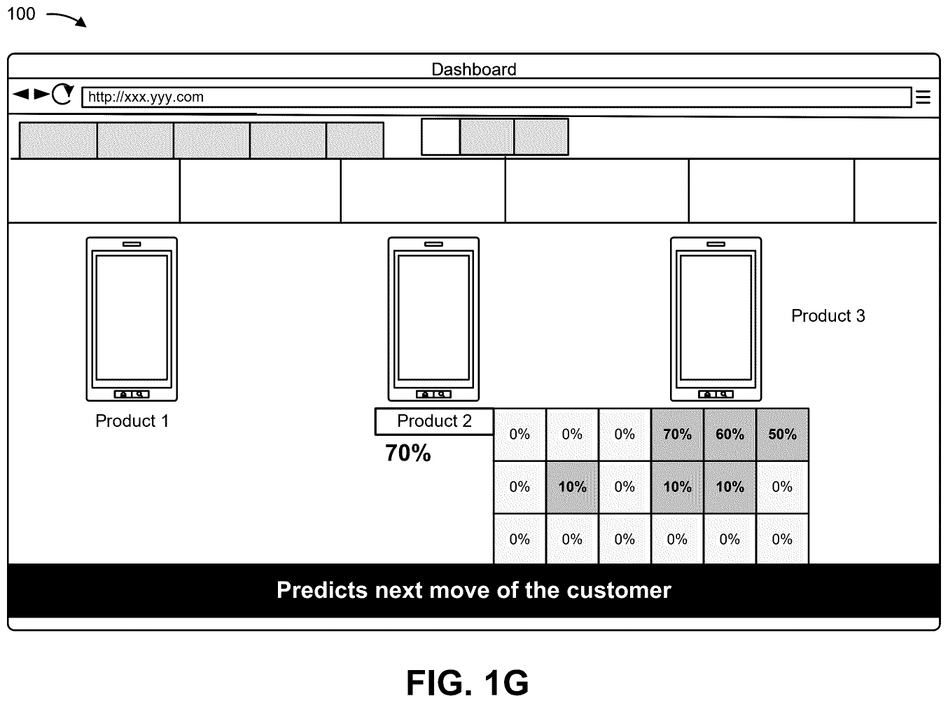

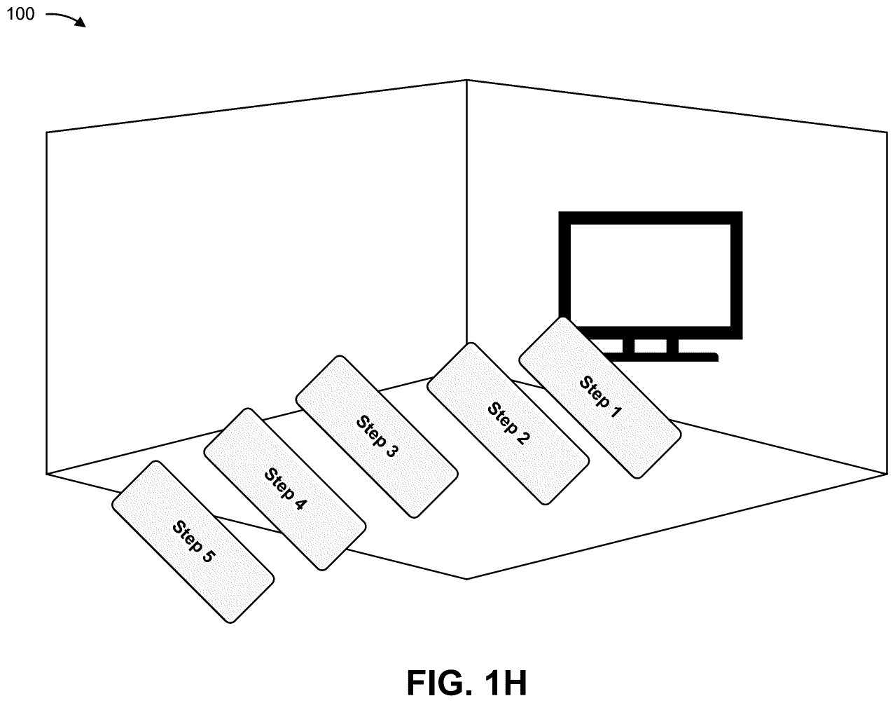

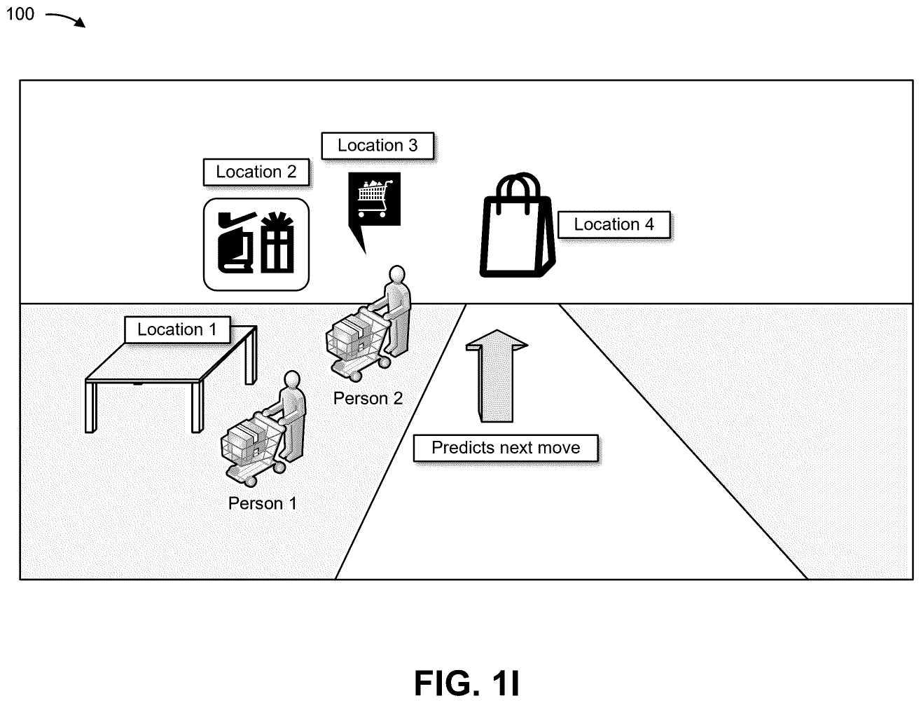

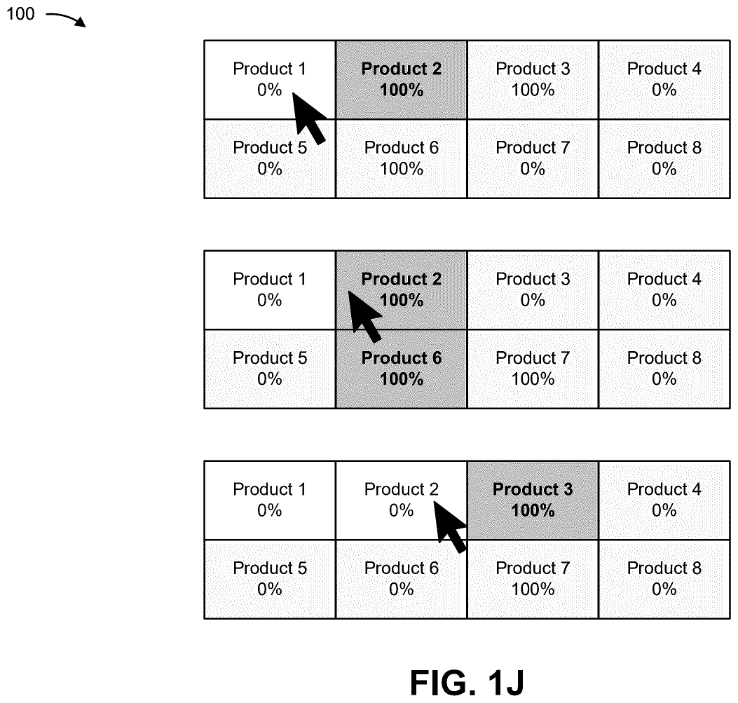

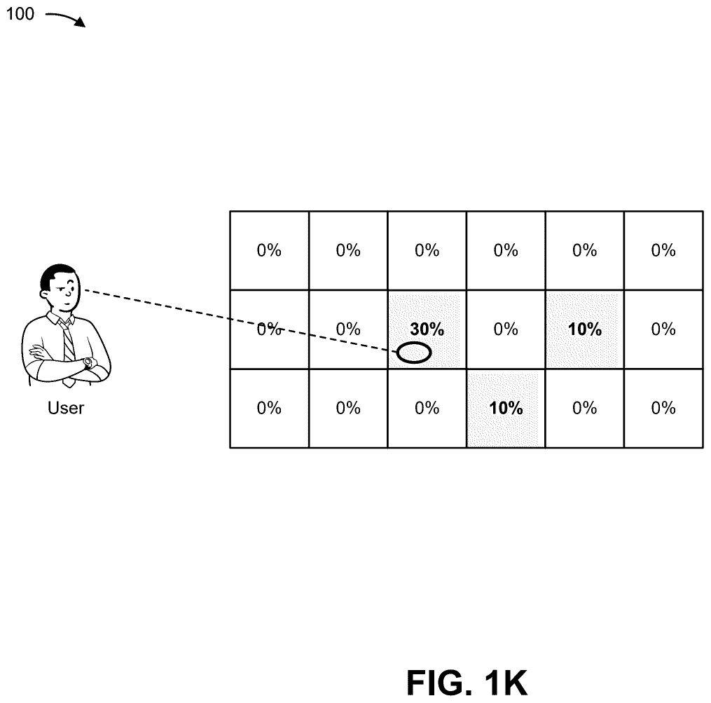

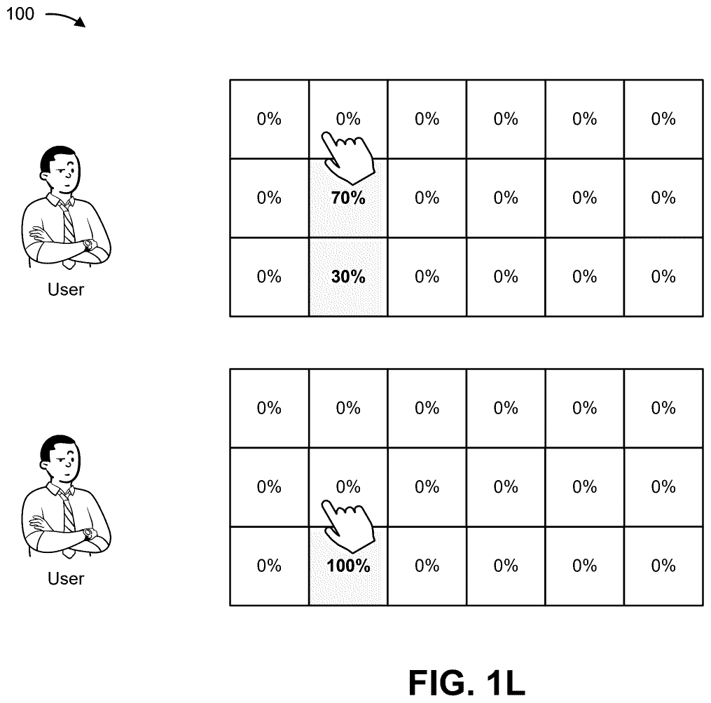

FIGS. 1A-1L are diagrams of an example 100 associated with tracking actions of a user of a digital channel and for predicting a next action of the user. As shown in FIGS. 1A-1L, example 100 includes a user device 105 (e.g., associated with users), a camera 110, and a backend system 115. In some implementations, the camera 110 may be included in the user device 105, separate from the user device 105, and/or the like. Further details of the user device 105, the camera 110, and the backend system 115 are provided elsewhere herein. In some implementations, one or more of the functions described herein as being performed by the backend system 115 may be performed by the user device 105.

As shown in FIG. 1A, and by reference number 120, the backend system 115 may generate or identify a domain associated with a user of the user device 105. For example, the user and the user device 105 may be associated with a domain in which the user is present or that is generated by the backend system 115. In some implementations, the domain may include a video display provided to the user via the user device 105. In such implementations, the video display may include one or more user interfaces generated by the backend system 115 and provided to the user device 105. The user device 105 may display the one or more user interfaces to the user via the video display.

In some implementations, the domain may include a real-world environment of the user. In such implementations, the user device 105 and/or the camera 110 may capture the real-world environment of the user as images (e.g., video) of the user while the user is near the user device 105 and/or the camera 110. The user device 105 and/or the camera 110 may provide the images to the backend system 115, and the backend system 115 may receive the images. In some implementations, the backend system 115 may continuously receive the images from the user device 105 and/or the camera 110, may periodically receive the images from the user device 105 and/or the camera 110, and/or the like. The backend system 115 may identify the images as the domain associated with the user, and may process each of the images as described below in connection with a single image.

In some implementations, the domain may include a virtual reality environment of the user. In such implementations, the user device 105 or the backend system 115 may generate the virtual reality environment. When the user device 105 generates the virtual reality environment, the backend system 115 may receive the virtual reality environment from the user device 105 and may identify the virtual reality environment as the domain. Alternatively, when the user device 105 does not generate the virtual reality environment, the backend system 115 may generate the virtual reality environment.

In some implementations, the domain may include an augmented reality environment of the user. In such implementations, the user device 105 or the backend system 115 may generate the augmented reality environment. When the user device 105 generates the augmented reality environment, the backend system 115 may receive the augmented reality environment from the user device 105 and may identify the augmented reality environment as the domain of the user. Alternatively, when the user device 105 does not generate the augmented reality environment, the backend system 115 may generate the augmented reality environment as the domain of the user.

In some implementations, the domain may include a mixed reality environment of the user. In such implementations, the user device 105 or the backend system 115 may generate the mixed reality environment. When the user device 105 generates the mixed reality environment, the backend system 115 may receive the mixed reality environment from the user device 105 and may identify the mixed reality environment as the domain of the user. Alternatively, when the user device 105 does not generate the mixed reality environment, the backend system 115 may generate the mixed reality environment as the domain of the user.

As further shown in FIG. 1A, and by reference number 125, the backend system 115 may identify domain elements in the domain and may convert the domain to a knowledge graph with nodes and edges. For example, the domain of the user may include domain elements. When the domain is the video display, the domain elements may include elements of a user interface displayed by the video display, such as products displayed in the user interface, services displayed in the user interface, selectable mechanisms (e.g., images, icons, links, and/or the like) of the user interface that, when selected, cause the user to move to a different user interface, exit an application, purchase a product or a service, and/or the like.

When the domain is a virtual reality environment, the domain elements may include images virtually displayed to the user in the virtual reality environment. For example, the domain elements may include virtual images of products, virtual images of services, virtual selectable mechanisms (e.g., images, icons, links, and/or the like) that, when selected, cause the user to move to a different virtual reality environment, exit the virtual reality environment, purchase a product or a service of the virtual reality environment, and/or the like.

When the domain is an augmented reality environment, the domain elements may include images virtually displayed to the user in the augmented reality environment. For example, the domain elements may include virtual images of products, virtual images of services, virtual selectable mechanisms (e.g., images, icons, links, and/or the like) that, when selected, cause the user to move to a different augmented reality environment, exit the augmented reality environment, purchase a product or a service of the augmented reality environment, and/or the like.

When the domain is a mixed reality environment, the domain elements may include images virtually displayed to the user in the mixed reality environment. For example, the domain elements may include virtual images of products, virtual images of services, virtual selectable mechanisms (e.g., images, icons, links, and/or the like) that, when selected, cause the user to move to a different mixed reality environment, exit the mixed reality environment, purchase a product or a service of the mixed reality environment, and/or the like.

In some implementations, the backend system 115 may identify the domain elements in the different types of domains and may convert the domain elements to nodes of a knowledge graph. The nodes of the knowledge graph may represent the domain elements of the domain. The backend system 115 may provide edges between the nodes of the knowledge graph, where each of the edges of the knowledge graph may correspond to a distance between nodes joined by each of the edges. A knowledge graph may represent a network of real-world entities (e.g., objects, events, situations, or concepts) and may illustrate relationships between them. This information may be stored in a graph database and may be visualized as a graph structure.

As further shown in FIG. 1A, and by reference number 130, the backend system 115 may receive one or more movements of an input associated with the domain. In some implementations, the user may provide an input associated with the domain via one or more movements. For example, when the domain is a user interface displayed to the user, the input may include one or more movements provided by a mouse cursor provided by the user device 105, a facial cursor provided by the user device 105 and the camera 110, a hand cursor provided by the user device 105 and the camera 110, a body movement of the user via the user device 105 and the camera 110. In some implementations, the user device 105 (e.g., a virtual headset) or the camera 110 may capture images (e.g., video) of the user while the user are near the user device 105 or the camera 110. The images may include the one or more movements of the input associated with the domain.

When the domain is a virtual reality environment, the input may include one or more movements provided by a virtual reality controller of the user device 105, a virtual reality headset of the user device 105, a head of the user (e.g., as captured by the virtual reality headset), a hand of the user (e.g., as captured by the virtual reality headset), and/or the like. When the domain is an augmented reality environment, the input may include one or more movements provided by an augmented reality controller of the user device 105, an augmented reality headset of the user device 105, a head of the user (e.g., as captured by the augmented reality headset), a hand of the user (e.g., as captured by the augmented reality headset), and/or the like. When the domain is a mixed reality environment, the input may include one or more movements provided by a mixed reality controller of the user device 105, a mixed reality headset of the user device 105, a head of the user (e.g., as captured by the mixed reality headset), a hand of the user (e.g., as captured by the mixed reality headset), and/or the like. In some implementations, the backend system 115 may continuously receive the one or more movements of the input, may periodically receive the one or more movements of the input, and/or the like.

As shown in FIG. 1B, and by reference number 135, the backend system 115 may predict positions of the input within the knowledge graph based on the one or more movements and may identify closest nodes to the positions. For example, the backend system 115 may predict positions of the input within the knowledge graph (e.g., relative to the nodes of the knowledge graph) based on the one or more movements. In some implementations, the backend system 115 may calculate a velocity and/or a direction of the input based on the one or more movements (e.g., over a time period). For example, to calculate the velocity of the input, the backend system 115 may interpolate the one or more movements as a linear curve (e.g., with x and y values associated with the domain) and may determine derivatives of the x and y values to calculate the velocity of the input. The backend system 115 may predict the positions of the input within the knowledge graph based on the velocity and/or the direction of the input. In some implementations, the backend system 115 may calculate an acceleration of the input based on the one or movements, and may predict the positions of the input within the knowledge graph based on the acceleration of the input.

In some implementations, the backend system 115 may identify the closest nodes of the knowledge graph to the predicted positions of the input in the knowledge graph. For example, if a current position of the input indicates that the input is at a first node of the knowledge graph, the backend system 115 may calculate distances (e.g., edges) between the first node and other nodes of the knowledge graph that surround the first node. The backend system 115 may identify the closest nodes of the knowledge graph to the first node based on the calculated distances.

As further shown in FIG. 1B, and by reference number 140, the backend system 115 may determine particular domain elements that correspond to the closest nodes. For example, the backend system 115 may correlate the identified closest nodes with the particular domain elements represented by the identified closest nodes in the knowledge graph. In some implementations, a closest node may represent an icon (e.g., a particular domain element) of a user interface (e.g., a domain) and the backend system 115 may determine that the icon corresponds to the closest node.

As shown in FIG. 1C, and by reference number 145, the backend system 115 may assign a counter value to each of the particular domain elements based on traversal by the input and may increase a total value based on each of the counter values. For example, the backend system 115 may assign a counter value to each of the particular domain elements that correspond to the closest nodes and that are traversed by the input over time. In some implementations, the particular domain element may include an icon of a user interface and the backend system 115 may assign a counter value to the icon. Every time the icon is traversed (e.g., selected, hovered over, and/or the like) by the user, the backend system 115 may increase the counter value assigned to the icon. For example, if the icon is hovered over three times during a time period, the counter value for the icon may be set to three. The backend system 115 may assign corresponding counter values to other particular domain elements in a similar manner. In some implementations, the backend system 115 may increase the total value based on each of the counter values at a particular time. For example, if counter values for the particular domain elements are four, five, and one at the particular time, the total value may be ten at the particular time.

As shown in FIG. 1D, and by reference number 150, the backend system 115 may divide the counter values by the total value to calculate probabilities that the input will traverse corresponding particular domain elements. For example, the backend system 115 may divide a counter value assigned to a particular domain element by the total value to calculate a probability that the input will traverse the particular domain element. The backend system 115 may repeat this calculation for each of the counter values assigned to each of the particular domain elements. This may result in probabilities (e.g., decimals, percentages, and/or the like) being assigned to the particular domain elements. The probabilities may provide an indication of the likelihoods that the input will traverse the corresponding particular domain elements.

In some implementations, the probabilities may enable the backend system 115 to track user behavior in real time by proactively predicting a next move of the user in the domain. The backend system 115 may utilize proactive predictions of next moves of the user to take actions, such as prevent the user from leaving a domain (e.g., a digital channel) by providing the user with an offer, providing chat assistance to the user, connecting the user to an agent, and/or the like. In some implementations, the backend system 115 may proactively track and predict a next viewpoint of the user while the user is shopping in a real world environment, such as the retail store. The backend system 115 may utilize the probabilities to generate patterns of the user in real time, which may enable the backend system 115 to differentiate between a human user or a bot (e.g., to provide additional security and to address multiple issues associated with passkeys, captcha, and/or the like). The backend system 115 may utilize the movements of the user as a security passkey or as a pattern to unlock a digital screen, and to predict a next best move for the user and/or a user journey.

As shown in FIG. 1E, and by reference number 155, the backend system 115 may perform one or more actions based on the probabilities that the input will traverse corresponding particular domain elements. In some implementations, performing the one or more actions includes the backend system 115 displaying, to the user, an offer associated with one of the corresponding particular domain elements. For example, the probabilities may indicate that the user is interested in one of the corresponding domain elements (e.g., a product image displayed on a user interface). The backend system 115 may identify an offer for the product and may provide the offer for display to the user via the user device 105. The offer may entice the user to purchase the product. In this way, the backend system 115 conserves computing resources, networking resources, and/or other resources that would have otherwise been consumed by failing to properly assist a user in a store or online with a product and/or a service.

In some implementations, performing the one or more actions includes the backend system 115 displaying, to the user, targeted content associated with one of the corresponding particular domain elements. For example, the probabilities may indicate that the user is interested in one of the corresponding domain elements (e.g., a service offered via a user interface). The backend system 115 may identify targeted content (e.g., an advertisement) for the service and may provide the targeted content for display to the user via the user device 105. The targeted content may entice the user to purchase the service. In this way, the backend system 115 conserves computing resources, networking resources, and/or other resources that would have otherwise been consumed by failing to provide recommendations to a user of an online purchasing system due to poor insights.

In some implementations, performing the one or more actions includes the backend system 115 providing, to the user, assistance associated with one of the corresponding particular domain elements. For example, the probabilities may indicate that the user is seeking help associated with one of the corresponding domain elements (e.g., repairing a network device). The backend system 115 may identify assistance (e.g., technical documentation for network device, a telephone number for contacting technical assistance, and/or the like) for the network device and may provide the assistance to the user via the user device 105. The user may utilize the assistance to repair the network device. In this way, the backend system 115 conserves computing resources, networking resources, and/or other resources that would have otherwise been consumed by failing to properly assist a user with a product and/or a service.

In some implementations, performing the one or more actions includes the backend system 115 connecting the user with a customer service agent based on one of the corresponding particular domain elements. For example, the probabilities may indicate that the user is seeking help associated with one of the corresponding domain elements (e.g., adding a new service). The backend system 115 may connect the user with a customer service agent that may assist the user with adding a new service. The user may add the new service based on interacting with the customer service agent. In this way, the backend system 115 conserves computing resources, networking resources, and/or other resources that would have otherwise been consumed by providing incorrect recommendations to a user due to the poor insights.

In some implementations, performing the one or more actions includes the backend system 115 determining that the user will exit the domain and attempting to prevent the user from exiting the domain. For example, the probabilities may indicate that the user is exiting the domain (e.g., closing a browser window). The backend system 115 may identify a pop-up advertisement that may interest the user, and may provide the pop-up advertisement for display to the user via the user device 105. The user may view the pop-up advertisement and continue to utilize the domain based on the pop-up advertisement. In this way, the backend system 115 conserves computing resources, networking resources, and/or other resources that would have otherwise been consumed by losing a customer associated with a domain (e.g., an online store).

In some implementations, performing the one or more actions includes the backend system 115 authenticating the user based on one of the corresponding particular domain elements. For example, the probabilities may indicate that the user is interacting with the one of the corresponding particular domain elements (e.g., an image) in a particular way (e.g., by selecting particular images). The backend system 115 may utilize the interaction of the user with the one of the corresponding particular domain elements as a mechanism to identify and authenticate the user for accessing and/or utilizing the domain. In this way, the backend system 115 conserves computing resources, networking resources, and/or other resources that would have otherwise been consumed by handling security breaches associated with domains, preventing bad actors from accessing domains, and/or the like.

FIG. 1F depicts an example of the backend system 115 predicting an exit of a user from a domain (e.g., user interface) in real time. For example, the backend system 115 may identify domain elements that are likely to be traversed by the user, and may assign probabilities (e.g., percentages) to the domain elements. As the user gets nearer to the top of the user interface and closer to a close button, the backend system 115 may highlight the domain elements traversed by the input and may provide probabilities for the highlighted domain elements before the user reaches the close button of the user interface. As the user approaches the domain elements nearer to the close button, the backend system 115 may trigger an action (e.g., provide an offer to the user) to prevent the user from exiting the user interface. The probabilities may increase as the user moves the input towards the close button of the user interface.

In some implementations, the backend system 115 may predict a likeliness of a user canceling a transaction or converting a transaction in real time. For example, the backend system 115 may create, on the domain elements, a virtual box with a fixed width and a fixed height. The virtual box may define a region around the domain elements in a viewing region and the backend system 115 may store the domain elements in an array. As the user scrolls on an application, the virtual box may scroll and may identify upcoming domain elements that are outside the region covered by the virtual box. The backend system 115 may predict the domain elements that are likely to be traversed by the virtual box before the virtual box reaches and covers the predicted domain elements. As soon as a probability of the virtual box traversing a predicted domain element increases, the backend system 115 may validate the domain element and perform an action that assists the user.

FIG. 1G depicts an example of the backend system 115 tracking and predicting whether the user will add a product to an online shopping cart. For example, the backend system 115 may generate a prediction even before an input moves towards the product. The backend system 115 may predict that that user is going to interact with the product and may provide an indication (e.g., a label, a highlighted color, and/or the like) of a likelihood that the user will interact with the product.

FIG. 1H depicts an example of the backend system 115 predicting user movements in a real world environment and proactively assisting the user based on the movements. For example, the backend system 115 may track real world objects, such as a person, and may map an input in the digital world against grids. As the user walks, the backend system 115 may track the walking movement and may capture the movement on a canvas of an application.

FIG. 1I depicts an example of the backend system 115 predicting user movements in a real world environment and proactively assisting to the user based on the movements. For example, when the user walks in a store (e.g., a retail store) from one location to another location, the backend system 115 may predict a next move of the user based on a velocity and a displacement of the user. The backend system 115 may track and map the user as an input on grids, and determine a velocity of the user's movement. Based on the velocity of the user's movement, the backend system 115 may predict a grid that may be interacted with in the near future. The possibility of grids being interacted with may enable determination of the user movements. The backend system 115 may utilize the user movements to proactively display an offer for a product on digital signage located near the user or to provide assistance to the user through a digital bot.

FIG. 1J depicts an example of the backend system 115 predicting a viewpoint of the user in a real world environment and providing proactive assistance to the user. The ability to understand the viewpoint of the user based on a direction of the user's head and on a velocity of the user's head, may enable the backend system 115 to predict a next viewpoint of the user. This may enable the backend system 115 to proactively place a product at the next viewpoint or to provide proactive assistance to the user at the next viewpoint.

FIG. 1K depicts an example of the backend system 115 predicting head movements of the user in a real world environment and providing proactive assistance to the user. The user may interact with the backend system 115 via a facial cursor or via head movements. The circle may provide an indication of the facial cursor. The backend system 115 may track movements of the facial cursor and may predict a next possible move of the facial cursor, which may indicate a viewpoint of the user. This may enable the backend system 115 to understand user behavior while the user is using a contactless browsing experience either by eye gaze or via the facial cursor.

FIG. 1L depicts an example of the backend system 115 predicting hand movements of the user in a real world environment and providing proactive assistance to the user. The user may interact with the backend system 115 via a hand cursor. The hand image may correspond to the hand cursor. The backend system 115 may track movements of the hand cursor and may predict a next possible move of the hand cursor, which may indicate a viewpoint of the user. This may enable the backend system 115 to understand user behavior while the user is using a contactless browsing experience by using hand gestures.

In some implementations, the backend system 115 may utilize the prediction of a next move of a user to provide authentication of the user for accessing a domain. A rate at which the user moves an input may cause the backend system 115 to calculate a probability for interaction with a domain element and a distance between a current input position and the domain element. A rate at which the probability increases or decreases may enable the backend system 115 to derive a pattern to unlock access to the domain.

In this way, the backend system 115 tracks actions of a user of a digital channel and predicts a next action of the user. For example, the backend system 115 may track movement of an input (e.g., a mouse cursor, a facial cursor, a hand cursor, or a body movement) associated with a user, and may calculate a velocity and a direction of the movement. The backend system 115 may predict a next interaction of the user, and may take proactive actions based on this prediction, such as displaying offers or providing real-time feedback to enhance user engagement. The backend system 115 may differentiate between human and non-human patterns (e.g., for authenticating the user), and may be employed in various domains, such as a video display, a real-world environment, a virtual reality environment, an augmented reality environment, or a mixed reality environment. The backend system 115 may improve efficiency, security, and resource utilization compared to traditional systems, and may offer businesses a sophisticated and resource-conserving system for understanding and responding to user behavior. Thus, the backend system 115 may conserve computing resources, networking resources, and/or other resources that would have otherwise been consumed by failing to properly assist a user in a store or online with a product and/or a service, losing a customer associated with a store, failing to provide recommendations to a user of an online purchasing system due to poor insights, providing incorrect recommendations to a user of an online purchasing system due to the poor insights, and/or the like.

As indicated above, FIGS. 1A-1L are provided as an example. Other examples may differ from what is described with regard to FIGS. 1A-1L. The number and arrangement of devices shown in FIGS. 1A-1L are provided as an example. In practice, there may be additional devices, fewer devices, different devices, or differently arranged devices than those shown in FIGS. 1A-1L. Furthermore, two or more devices shown in FIGS. 1A-1L may be implemented within a single device, or a single device shown in FIGS. 1A-1L may be implemented as multiple, distributed devices. Additionally, or alternatively, a set of devices (e.g., one or more devices) shown in FIGS. 1A-1L may perform one or more functions described as being performed by another set of devices shown in FIGS. 1A-1L.

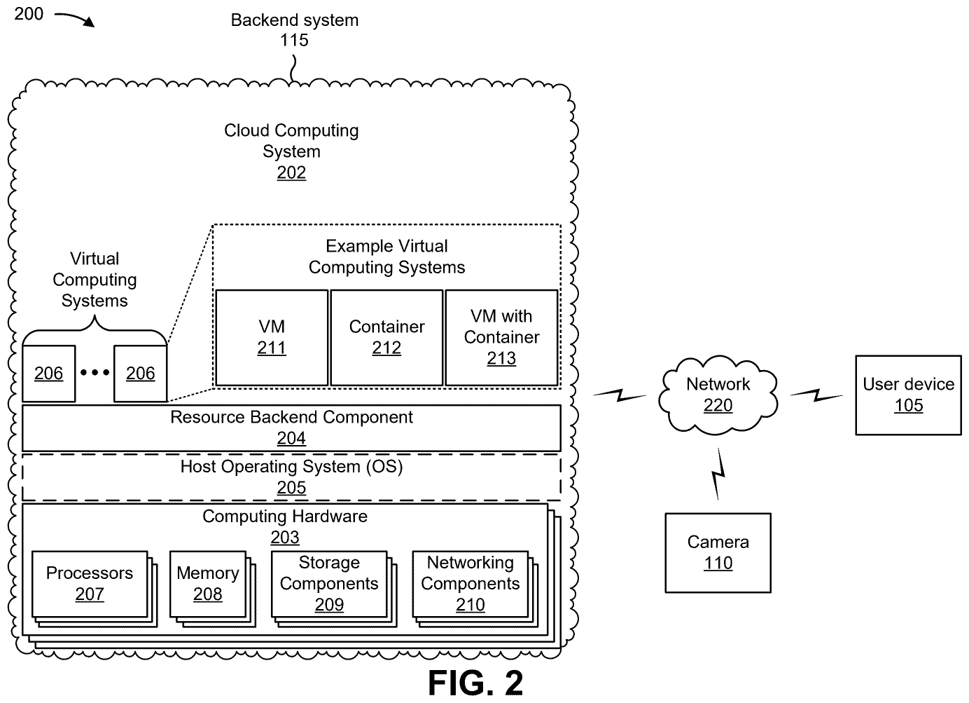

FIG. 2 is a diagram of an example environment 200 in which systems and/or methods described herein may be implemented. As shown in FIG. 2, the environment 200 may include the backend system 115, which may include one or more elements of and/or may execute within a cloud computing system 202. The cloud computing system 202 may include one or more elements 203-213, as described in more detail below. As further shown in FIG. 2, the environment 200 may include the user device 105 and/or a network 220. Devices and/or elements of the environment 200 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), a virtual assistant device, or a similar type of device.

The camera 110 may include one or more devices capable of receiving, generating, storing, processing, providing, and/or routing information, as described elsewhere herein. The camera 110 may include a communication device and/or a computing device. For example, the camera 110 may include an optical instrument that captures images, audio, and/or videos (e.g., images and audio). The camera 110 may feed real-time images and/or video directly to the user device 105 or the display of the user device 105, may record captured images and/or video to a storage device for archiving or further processing, and/or the like.

The cloud computing system 202 includes computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of the computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from the computing hardware 203 of the single computing device. In this way, the computing hardware 203 can operate more efficiently, with lower power consumption, higher reliability, higher availability, higher utilization, greater flexibility, and lower cost than using separate computing devices.

The computing hardware 203 includes hardware and corresponding resources from one or more computing devices. For example, the computing hardware 203 may include hardware from a single computing device (e.g., a single server) or from multiple computing devices (e.g., multiple servers), such as multiple computing devices in one or more data centers. As shown, the computing hardware 203 may include one or more processors 207, one or more memories 208, one or more storage components 209, and/or one or more networking components 210. Examples of a processor, a memory, a storage component, and a networking component (e.g., a communication component) are described elsewhere herein.

The resource management component 204 includes a virtualization application (e.g., executing on hardware, such as the computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 211. Additionally, or alternatively, the resource management component 204 may include a container manager, such as when the virtual computing systems 206 are containers 212. In some implementations, the resource management component 204 executes within and/or in coordination with a host operating system 205.

A virtual computing system 206 includes a virtual environment that enables cloud-based execution of operations and/or processes described herein using the computing hardware 203. As shown, the virtual computing system 206 may include a virtual machine 211, a container 212, or a hybrid environment 213 that includes a virtual machine and a container, among other examples. The virtual computing system 206 may execute one or more applications using a file system that includes binary files, software libraries, and/or other resources required to execute applications on a guest operating system (e.g., within the virtual computing system 206) or the host operating system 205.

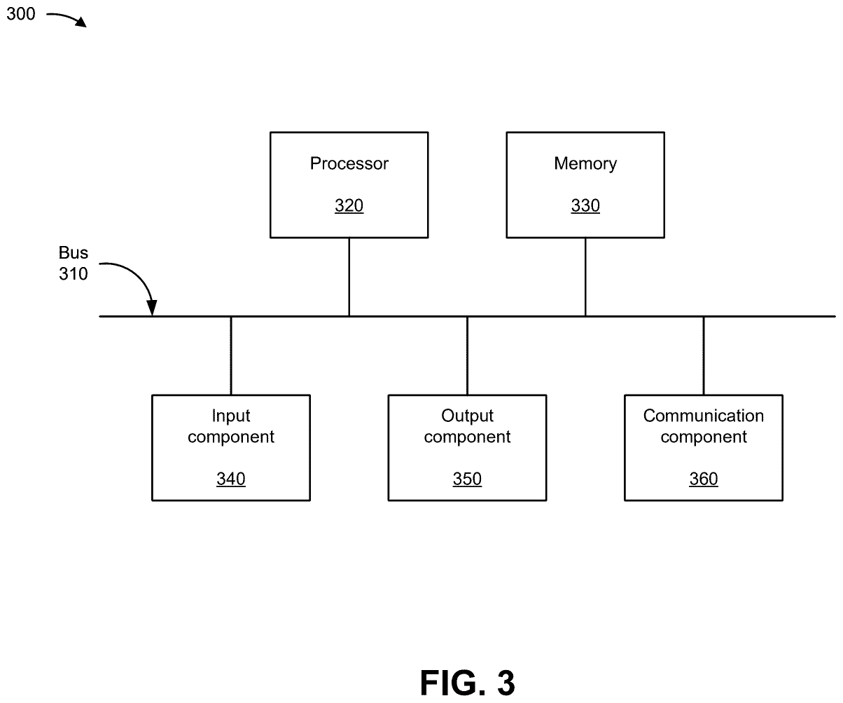

Although the backend system 115 may include one or more elements 203-213 of the cloud computing system 202, may execute within the cloud computing system 202, and/or may be hosted within the cloud computing system 202, in some implementations, the backend system 115 may not be cloud-based (e.g., may be implemented outside of a cloud computing system) or may be partially cloud-based. For example, the backend system 115 may include one or more devices that are not part of the cloud computing system 202, such as the device 300 of FIG. 3, which may include a standalone server or another type of computing device. The backend system 115 may perform one or more operations and/or processes described in more detail elsewhere herein.

The network 220 includes one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300, which may correspond to the user device 105, the camera 110, and/or the backend system 115. In some implementations, the user device 105, the camera 110, and/or the backend system 115 may include one or more devices 300 and/or one or more components of the device 300. As shown in FIG. 3, the device 300 may include a bus 310, a processor 320, a memory 330, an input component 340, an output component 350, and a communication component 360.

The bus 310 includes one or more components that enable wired and/or wireless communication among the components of the device 300. The bus 310 may couple together two or more components of FIG. 3, such as via operative coupling, communicative coupling, electronic coupling, and/or electric coupling. The processor 320 includes a central processing unit, a graphics processing unit, a microprocessor, a controller, a microcontroller, a digital signal processor, a field-programmable gate array, an application-specific integrated circuit, and/or another type of processing component. The processor 320 is implemented in hardware, firmware, or a combination of hardware and software. In some implementations, the processor 320 includes one or more processors capable of being programmed to perform one or more operations or processes described elsewhere herein.

The memory 330 includes volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 stores information, instructions, and/or software (e.g., one or more software applications) related to the operation of the device 300. In some implementations, the memory 330 includes one or more memories that are coupled to one or more processors (e.g., the processor 320), such as via the bus 310.

The input component 340 enables the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 enables the device 300 to provide output, such as via a display, a speaker, and/or a light-emitting diode. The communication component 360 enables the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., the memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

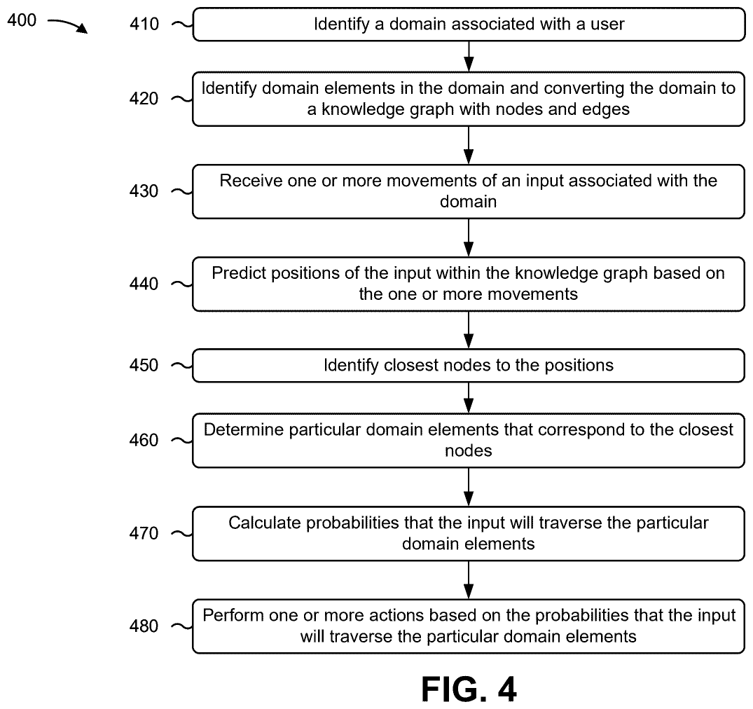

FIG. 4 is a flowchart of an example process 400 for tracking actions of a user of a digital channel and for predicting a next action of the user. In some implementations, one or more process blocks of FIG. 4 may be performed by a device (e.g., the backend system 115). In some implementations, one or more process blocks of FIG. 4 may be performed by another device or a group of devices separate from or including the device, such as a user device (e.g., the user device 105) and/or a camera (e.g., the camera 110). Additionally, or alternatively, one or more process blocks of FIG. 4 may be performed by one or more components of the device 300, such as the processor 320, the memory 330, the input component 340, the output component 350, and/or the communication component 360.

As shown in FIG. 4, process 400 may include identifying a domain associated with a user (block 410). For example, the device may identify a domain associated with a user of a user device, as described above.

As further shown in FIG. 4, process 400 may include identifying domain elements in the domain and converting the domain to a knowledge graph with nodes and edges (block 420). For example, the device may identify domain elements in the domain and may convert the domain to a knowledge graph with nodes and edges, as described above. In some implementations, each of the nodes of the knowledge graph corresponds to one of the domain elements, and each of the edges of the knowledge graph corresponds to a distance between nodes joined by each of the edges.

As further shown in FIG. 4, process 400 may include receiving one or more movements of an input associated with the domain (block 430). For example, the device may receive one or more movements of an input associated with the domain, as described above. In some implementations, the input is associated with one of a mouse cursor, a facial cursor, a hand cursor, or a body movement of the user.

As further shown in FIG. 4, process 400 may include predicting positions of the input within the knowledge graph based on the one or more movements (block 440). For example, the device may predict positions of the input within the knowledge graph based on the one or more movements, as described above.

As further shown in FIG. 4, process 400 may include identifying closest nodes to the positions (block 450). For example, the device may identify closest nodes to the positions, as described above.

As further shown in FIG. 4, process 400 may include determining particular domain elements that correspond to the closest nodes (block 460). For example, the device may determine particular domain elements that correspond to the closest nodes, as described above.

As further shown in FIG. 4, process 400 may include calculating probabilities that the input will traverse the particular domain elements (block 470). For example, the device may calculate probabilities that the input will traverse the particular domain elements, as described above. In some implementations, calculating the probabilities that the input will traverse the particular domain elements includes assigning respective counter values to the particular domain elements based on traversal by the input, increasing a total value based on each of the counter values, and dividing the counter values by the total value to calculate the probabilities that the input will traverse the particular domain elements.

As further shown in FIG. 4, process 400 may include performing one or more actions based on the probabilities that the input will traverse the particular domain elements (block 480). For example, the device may perform one or more actions based on the probabilities that the input will traverse the particular domain elements, as described above. In some implementations, performing the one or more actions includes one or more of displaying, to the user, an offer associated with one of the particular domain elements, or displaying, to the user, targeted content associated with one of the particular domain elements. In some implementations, performing the one or more actions includes one or more of providing, to the user, assistance associated with one of the particular domain elements, or connecting the user with a customer service agent based on one of the particular domain elements. In some implementations, performing the one or more actions includes one or more of determining that the user will exit the domain and attempting to prevent the user from exiting the domain, or authenticating the user based on one of the particular domain elements.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

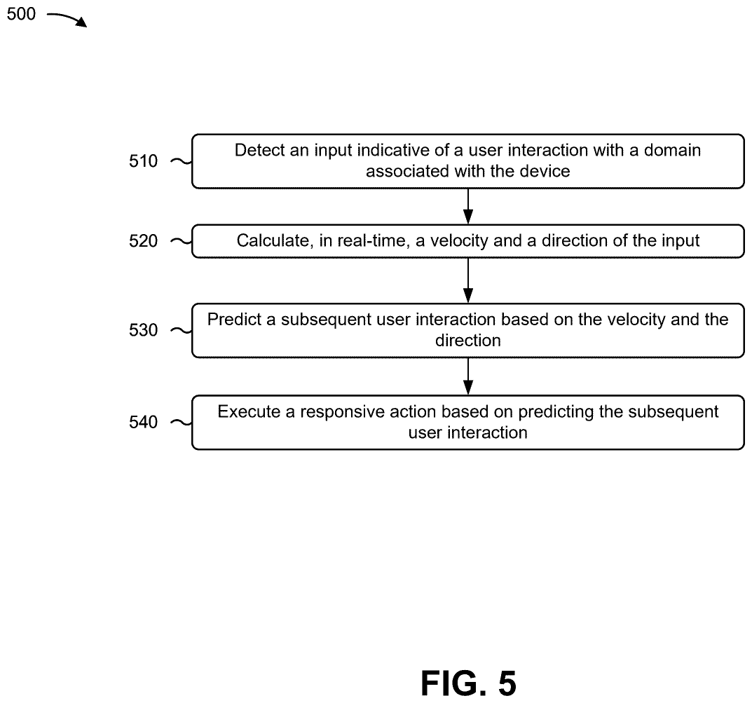

FIG. 5 is a flowchart of an example process 500 for tracking actions of a user of a digital channel and for predicting a next action of the user. In some implementations, one or more process blocks of FIG. 5 may be performed by a device (e.g., the backend system 115). In some implementations, one or more process blocks of FIG. 5 may be performed by another device or a group of devices separate from or including the device, such as a user device (e.g., the user device 105) and/or a camera (e.g., the camera 110). Additionally, or alternatively, one or more process blocks of FIG. 5 may be performed by one or more components of the device 300, such as the processor 320, the memory 330, the input component 340, the output component 350, and/or the communication component 360.

As shown in FIG. 5, process 500 may include detecting an input indicative of a user interaction with a domain associated with the device (block 510). For example, the device may detect an input indicative of a user interaction with a domain associated with the device, as described above. In some implementations, the domain includes one of a video display, a real-world environment, a virtual reality environment, an augmented reality environment, or a mixed reality environment.

As further shown in FIG. 5, process 500 may include calculating, in real-time, a velocity and a direction of the input (block 520). For example, the device may calculate, in real-time, a velocity and a direction of the input, as described above.

As further shown in FIG. 5, process 500 may include predicting a subsequent user interaction based on the velocity and the direction (block 530). For example, the device may predict a subsequent user interaction based on the velocity and the direction, as described above.

As further shown in FIG. 5, process 500 may include executing a responsive action based on predicting the subsequent user interaction (block 540). For example, the device may execute a responsive action based on predicting the subsequent user interaction, as described above.

In some implementations, process 500 includes adjusting the responsive action based on a type of the detected input. In some implementations, process 500 includes generating a visual representation of the predicted subsequent user interaction, and providing the visual representation for display. In some implementations, process 500 includes providing an offer or assistance to the user in response to the predicted subsequent user interaction. In some implementations, process 500 includes determining whether the input is a user input and a non-user input based on the velocity and the direction of the input, and authenticating the user based on determining that the input is a user input. In some implementations, process 500 includes modifying the responsive action based on historical user interaction data.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a−b, a−c, b−c, and a−b−c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
identifying, by a device, a domain associated with a user;
identifying, by the device, domain elements in the domain and converting the domain to a knowledge graph with nodes and edges;
receiving, by the device, one or more movements of an input associated with the domain;
predicting, by the device, positions of the input within the knowledge graph based on the one or more movements;
identifying, by the device, closest nodes to the positions;
determining, by the device, particular domain elements that correspond to the closest nodes;
calculating, by the device, probabilities that the input will traverse the particular domain elements; and
performing, by the device, one or more actions based on the probabilities that the input will traverse the particular domain elements.

2. The method of claim 1, wherein calculating the probabilities that the input will traverse the particular domain elements comprises:
assigning respective counter values to the particular domain elements based on traversal by the input;
increasing a total value based on each of the counter values; and
dividing the counter values by the total value to calculate the probabilities that the input will traverse the particular domain elements.

3. The method of claim 1, wherein each of the nodes of the knowledge graph corresponds to one of the domain elements, and each of the edges of the knowledge graph corresponds to a distance between nodes joined by each of the edges.

4. The method of claim 1, wherein performing the one or more actions comprises one or more of:
displaying, to the user, an offer associated with one of the particular domain elements; or
displaying, to the user, targeted content associated with one of the particular domain elements.

5. The method of claim 1, wherein performing the one or more actions comprises one or more of:
providing, to the user, assistance associated with one of the particular domain elements; or
connecting the user with a customer service agent based on one of the particular domain elements.

6. The method of claim 1, wherein performing the one or more actions comprises one or more of:
determining that the user will exit the domain and attempting to prevent the user from exiting the domain; or
authenticating the user based on one of the particular domain elements.

7. The method of claim 1, wherein the input is associated with one of a mouse cursor, a facial cursor, a hand cursor, or a body movement of the user.

8. A device, comprising:
one or more processors configured to:
detect an input indicative of a user interaction with a domain associated with the device;
calculate, in real-time, a velocity and a direction of the input;
predict a subsequent user interaction based on the velocity and the direction; and
execute a responsive action based on predicting the subsequent user interaction.

9. The device of claim 8, wherein the one or more processors are further configured to:
adjust the responsive action based on a type of the detected input.

10. The device of claim 8, wherein the one or more processors are further configured to:
generate a visual representation of the predicted subsequent user interaction; and
provide the visual representation for display.

11. The device of claim 8, wherein the one or more processors are further configured to:
provide an offer or assistance to the user in response to the predicted subsequent user interaction.

12. The device of claim 8, wherein the one or more processors are further configured to:
determine whether the input is a user input and a non-user input based on the velocity and the direction of the input; and
authenticate the user based on determining that the input is a user input.

13. The device of claim 8, wherein the domain includes one of a video display, a real-world environment, a virtual reality environment, an augmented reality environment, or a mixed reality environment.

14. The device of claim 8, wherein the one or more processors are further configured to:
modify the responsive action based on historical user interaction data.

15. A non-transitory computer-readable medium storing a set of instructions, the set of instructions comprising:
one or more instructions that, when executed by one or more processors of a device, cause the device to:
identify a domain associated with a user;
identify domain elements in the domain and convert the domain to a knowledge graph with nodes and edges;
receive one or more movements of an input associated with the domain;
predict positions of the input within the knowledge graph based on the one or more movements;
identify closest nodes to the positions;
determine particular domain elements that correspond to the closest nodes;
assign respective counter values to the particular domain elements based on traversal by the input;
increase a total value based on each of the counter values;
divide the counter values by the total value to calculate probabilities that the input will traverse the particular domain elements; and
perform one or more actions based on the probabilities that the input will traverse the particular domain elements.

16. The non-transitory computer-readable medium of claim 15, wherein each of the nodes of the knowledge graph corresponds to one of the domain elements, and each of the edges of the knowledge graph corresponds to a distance between nodes joined by each of the edges.

17. The non-transitory computer-readable medium of claim 15, wherein the domain includes one of a video display, a real-world environment, a virtual reality environment, an augmented reality environment, or a mixed reality environment.

18. The non-transitory computer-readable medium of claim 15, wherein the one or more instructions, that cause the device to perform the one or more actions, cause the device to one or more of:
display, to the user, an offer associated with one of the particular domain elements;
display, to the user, targeted content associated with one of the particular domain elements; or
provide, to the user, assistance associated with one of the particular domain elements.

19. The non-transitory computer-readable medium of claim 15, wherein the one or more instructions, that cause the device to perform the one or more actions, cause the device to one or more of:
connect the user with a customer service agent based on one of the particular domain elements;
determine that the user will exit the domain and attempt to prevent the user from exiting the domain; or
authenticate the user based on one of the particular domain elements.

20. The non-transitory computer-readable medium of claim 15, wherein the input is associated with one of a mouse cursor, a facial cursor, a hand cursor, or a body movement of the user.
